(19) United States
(12) Patent Application Publication
(10) Pub. No.: US 2019/0187864 A1
(43) Pub. Date: Jun. 20, 2019

(54) PROVIDING OPTIMIZED DISPLAYS ON USER INTERFACES BASED ON USER GENERATED LISTS OF ITEMS

(71) Applicant: GOOGLE LLC, Mountain View, CA (US)

(72) Inventors: Shih-Hao Yeh, Santa Clara, CA (US); Navid Samadani-McQuirk, San Bruno, CA (US)

(21) Appl. No.: 16/132,307

(22) Filed: Sep. 14, 2018

Related U.S. Application Data
(60) Provisional application No. 62/607,028, filed on Dec. 18, 2017.

(51) Int. Cl. G06F 3/0482; G06F 17/30; G06Q 30/06

(52) U.S. Cl. CPC G06F 3/0482; G06Q 30/0633; G06F 17/3053; G06F 17/30867

(57) ABSTRACT

A system receives a request to generate a new list of items and transmits the new list of items to the user computing device for display via the user computing device. The user edits the displayed list of items. The system receives a request for recommended objects from the user computing device, retrieves a user activity history and user preferences, determines objects matching each item in the user generated list of items, and prepares an optimized display of recommended objects for presentation via the user interface of the user computing device. Based on any user activity history or user preferences, the system reorganizes the listings matching each item in the list of items. The system generates an optimized display of recommended objects comprising an organized string of recommended listings matching each item on the user generated list of items organized.

### CROSS REFERENCE TO RELATED APPLICATION

This application claims priority to U.S. Provisional Application No. 62/607,028 filed Dec. 18, 2017, and entitled “Providing Optimized Displays on User Interfaces Based on User Generated Lists of Items.” The entire contents of the above-identified priority application is hereby fully incorporated herein by reference.

### TECHNICAL FIELD

The technology disclosed herein relates to presenting recommended objects that correspond a user generated list of items, and more particularly to optimizing a presentation of objects on a user interface.

### BACKGROUND

Users often create simple lists that comprise a list of tasks and/or items. These lists are generally not helpful to the user in the context of electronic item recommendations because the user must still search for recommended listings that correspond to items on the user generated list. Conventional recommendation systems do not receive a user generated list and then provide recommended listings based on the user generated list and organize the recommended listings based on user preferences and past user behavior.

### SUMMARY

Techniques herein provide computer-implemented methods to generate graphical user interfaces comprising optimized displays of objects, comprising: receiving, by one or more computing devices, a first notification of selection of a first user interface element on a first graphical user interface of a user computing device requesting presentation of objects corresponding to each of a plurality of items in a list of item entries; determining, by the one or more computing devices, two or more objects, each object corresponding to a respective one of the plurality of items in the list of item entries; rendering, by the one or more computing devices, a second graphical user interface on the user computing device, the second graphical user interface comprising each of the two or more objects, wherein each of the two or more objects comprises a description corresponding to the respective one of the plurality of items in the list of item entries and a second user interface element to select the respective one of the plurality of items; receiving, by the one or more computing devices, a second notification of selection of the second user interface element on the second graphical user interface on the user computing device selecting a particular one of the two or more objects rendered on the second graphical user interface; receiving, by the one or more computing devices, a third notification of selection of a third user interface element on the second graphical user interface of the user computing device requesting a presentation of each selected object from the two or more objects rendered on the second graphical interface; and rendering, by the one or more computing devices, a third graphical user interface on the user computing device, the third graphical user interface comprising a display of each selected object.

Techniques herein provide computer-implemented methods to present recommended listings in a graphical user interface based on a user generated list of items. In an example, a user requests to generate a new list of items via an application. The user edits a displayed new list of items by adding one or more items, deleting one or more items, and/or modifying a quantity associated with one or more of the items on the displayed list of items. The user selects a user interface element to request generation of recommended listings based on the edited user generated list of items. The computing system receives the request for recommended listings from the user computing device, retrieves a user activity history and user preferences, determines one or more listings matching each item in the user generated list of items, and prepares an optimized display of recommended listings for presentation via the user interface of the user computing device. Based on any user activity history or user preferences, the computing system determines preferred listings from among recommended listings matching each item in the user generated list of items and reorganizes the listings for each item in the display of items by moving any preferred listings to the front of the string of recommended listings for the item. The computing system generates an optimized display of recommended listings comprising a string of recommended listings matching each item on the user generated list of items organized according to user preferences and user activity history.

In certain other example aspects described herein, systems and computer program products to present objects in a graphical user interface based on a user generated list of items are provided.

These and other aspects, objects, features, and advantages of the example embodiments will become apparent to those having ordinary skill in the art upon consideration of the following detailed description of illustrated examples.

### BRIEF DESCRIPTION OF THE DRAWINGS

FIG. 1 is a block diagram depicting a system to present a graphical user interface comprising product recommendations to a user based on a user generated list of items, in accordance with certain examples.

FIG. 2 is a block flow diagram depicting a method to present a graphical user interface comprising product recommendations to a user based on a user generated list of items, in accordance with certain examples.

FIG. 3 is a block flow diagram depicting a method to register, by a user, for an account with a product management computing system and download a application onto a user computing device, in accordance with certain examples.

FIG. 4 is a block flow diagram depicting a method to generate, by a user, a list of items, in accordance with certain examples.

FIG. 5 is a block flow diagram depicting a method to generate an optimized display of recommended product listings for display on a user interface of a user computing device, in accordance with certain examples.

FIG. 6 is an example illustration of a graphical user interface comprising a user generated list of items, in accordance with certain examples.

FIG. 7 is an example illustration of a graphical user interface comprising an optimized display of product recommendations, in accordance with certain examples.

FIG. 8 is a block diagram depicting a computing machine and a module, in accordance with certain examples.

### DETAILED DESCRIPTION OF THE EXAMPLE EMBODIMENTS

### Overview

Embodiments herein provide computer-implemented techniques for presenting recommended items based on a user generated list of items.

In an example, a user registers with a product management computing system and downloads an application by accessing a product management computing system website via a user computing device, registering for a user acount, entering account information, and downloading the application onto the user computing device. The user requests to generate a new list of items via the application or requests to retrieve a previous list of items. The product management computing system receives the request and retrieves the previous list of items or generates the new list of items in accordance with the request. The product management computing system transmits the previous user generated list of items or a display that allows the user to create a new user generated list of items to the user computing device for display via the user computing device. For example, a new user generated list of items comprises a blank list to which the user may add desired items. The user computing device displays the received user generated list of items and the user edits the displayed list of items. Editing the user generated list of items may comprise adding one or more items, deleting one or more items, and/or modifying a quantity associated with one or more items on the list of items. The user may select from preexisting item descriptions, enter text or photos of items, and/or speak a voice command to add items to the user generated list of items. In an example, the user selects a user interface element to request generation of a display of recommended objects based on the edited user generated list of items. For example, the user selects a user interface element that reads “search this list.”

The product management computing system receives the request for generation of recommended objects from the user computing device. The product management computing system retrieves user activity history and user preferences. The product management computing system determines recommended objects matching or corresponding to each item in the user generated list of items. The product management computing system prepares an optimized display of recommended objects for display on the user interface of the user computing device. For example, for each item in the user generated list of items, the product management computing system finds recommended objects matching the item and generates a string of recommended objects. For each item in the user generated list of items, the product management system determines whether the user has a preference for a particular object on the user generated list of items or whether the user has a history of user activity associated with any object on the user generated list of items. Based on any history of user activity or user preferences, the product management computing system determines preferred recommended objects from among recommended objects matching each item in the user generated list of items and the reorganizes the string of recommended objects matching each item on the user generated list of items by moving any preferred recommended objects to the front or other priority position of the string of recommended listings. The product management ocmputing system generates an optimized display of recommended object comprising a string of recommended listings matching each item on the user generated list of items organized according to relevant user preferences and user activity history.

The product management computing system transmits the optimized display of recommended objects to the user computing device and the user computing device displays the optimized display of recommended objects. The user selects one or more of the displayed recommended objects from the optimized display of recommended objects displayed on the user computing device. The user selects a user interface object to display of selected objects and selects a user interface object to initiate a service request process for the selected recommended listings.

By using and relying on the methods and systems described herein, the product management computing system intelligently provides product recommendations by taking a user generated list of items and presenting an optimized recommendation user interface that presents recommendations based on user preferences and user activity history. As such, the systems and methods described herein may be employed to simplify an online search experience of users searching for multiple items. Also, by using and relying on the methods and systems described herein, the product management computing system reduces its bandwidth usage by conducting a combined search for multiple items from a list of items instead of conducting separate sequential searches and providing separate results for each search. Further, by using and relying on the methods and systems described herein, the product management computing systems reduce inputs required by the user to search for items by conducting a combined search for recommendations based on a single list of items. As such, the systems and methods described herein may be employed to improve computer functionality by reducing the complexity of the data set such that it can be analyzed using more computationally efficient bitwise operations.

Various examples will be explained in more detail in the following description, read in conjunction with the figures illustrating the program flow.

Turning now to the drawings, in which like numerals represent like (but not necessarily identical) elements throughout the figures, example embodiments are described in detail.

### Example System Architectures

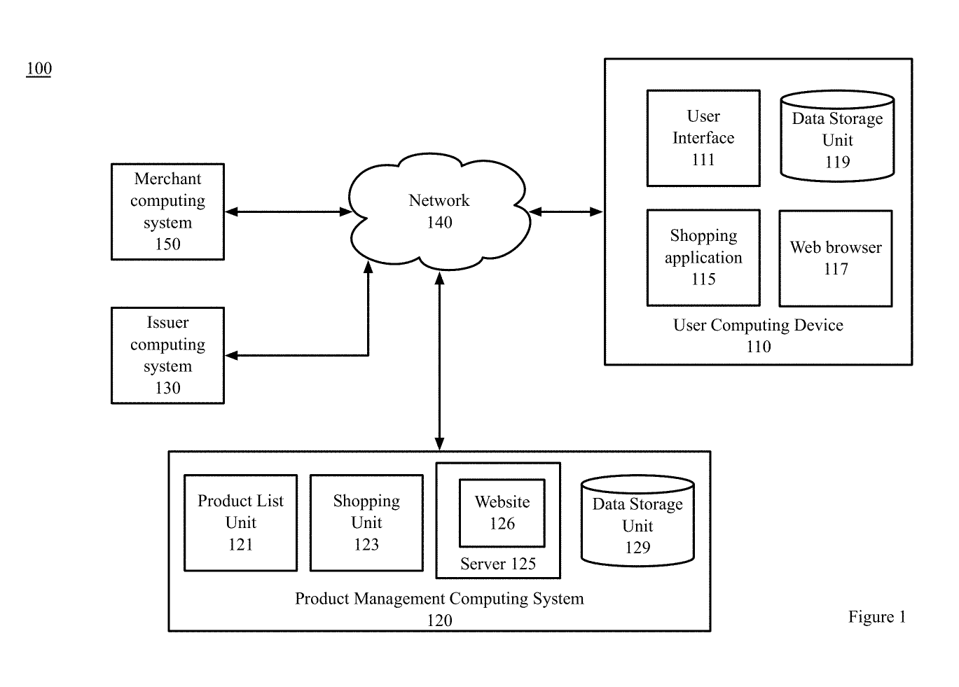

FIG. 1 is a block diagram depicting a system to present a graphical user interface comprising product recommendations based on a user generated list of items, in accordance with certain example embodiments. As depicted in FIG. 1, the example operating environment 100 comprises systems 110, 120, and 130 that are configured to communicate with one another via one or more networks 140 via network computing devices. In another example, two or more of these systems (including systems 110, 120, and 130) are integrated into the same system. In some examples, a user associated with a device must install an application and/or make a feature selection to obtain the benefits of the techniques described herein.

Each network 140 comprises a wired or wireless telecommunication mechanism by which network systems (including systems 110, 120, and 130) can communicate and exchange data. For example, each network 140 can include, be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, Bluetooth Low Energy (BLE), near field communication network (NFC), any form of standardized radio frequency, infrared, sound (for example, audible sounds, melodies, and ultrasound), other short range communication channel, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In an example, each network system (including systems 110, 120, and 130) comprises a device having a communication module capable of transmitting and receiving data over the network 140. For example, each network system (including systems 110, 120, and 130) may comprise a server, personal computer, mobile device (for example, notebook computer, handheld computer, tablet computer, netbook computer, personal digital assistant (PDA), video game device, GPS locator device, cellular telephone, Smartphone, or other mobile device), a television with one or more processors embedded therein and/or coupled thereto, an appliance with one or more processors embedded therein and/or coupled thereto, or other appropriate technology that comprises or is coupled to a web browser or other application for communicating via the network 140. In the example depicted in FIG. 1, the network systems (including systems 110, 120, and 130) are operated by users, product management computing system operators, and issuer system operators, respectively.

An example user computing device 110 comprises a user interface 111, application 115, and a data storage unit 119. In an example, the user computing device 110 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that comprises or is coupled to a web server (or other suitable application for interacting with web page files) or that comprises or is coupled to an application 115.

An user interface 111 comprises a touch screen, a voice-based interface, or any other interface that allows the user to provide input and receive output from the application 115. In an example, the user interacts with the application 115 via the user interface 111. The user can use the user computing device 110 to generate a new shopping list or access a previous shopping list via a user interface 111 and an application 115. The user can edit a shopping list via the application 115 and can request product recommendations to correspond to each item in the shopping list.

The application 115 is a program, function, routine, applet or similar entity that exists on and performs its operations on the user computing device 110. For example, the application 115 may be one or more of a application, a search application, an Internet browser, a digital wallet application, a loyalty card application, another value-added application, a user interface 111 application, or other suitable application operating on the user computing device 110. In some examples, the user must install an application 115 and/or make a feature selection on the user computing device 110 to obtain the benefits of the techniques described herein.

In an example, the user can use a communication application, such as a web browser 117 application or application 115, to view, download, upload, or otherwise access documents or web pages via a distributed network 140. In certain examples, one or more functions described herein as performed by the application 115 may be performed by the web browser 117. In certain examples, one or more functions described herein as performed by the web browser 117 may be performed by the application 115.

An example data storage unit 119 enables storage of user account details for retrieval of a user product management computing system 120 account. In an example, the data storage unit 119 can include any local or remote data storage structure accessible to the user computing device 110 suitable for storing information. In an example, the data storage unit 119 stores encrypted information, such as HTML5 local storage.

In an example, the data storage unit 119 and application 115 may be implemented in a secure element or other secure memory (not shown) on the user computing device 110. In another example, the data storage unit 119 may be a separate memory unit resident on the user computing device 110.

An example user computing device 110 comprises a secure element (not shown) or secure memory (not shown), which can exist within a removable smart chip or a secure digital (SD) card, which can be embedded within a fixed chip on the user computing device 110, or be realized as a secure compartment of a security-enhanced operating system. In certain examples, Subscriber Identity Module (SIM) cards may be capable of hosting a secure element, for example, an NFC SIM Card. The secure element allows the application 115 resident on the user computing device 110 and accessible by the device user to interact securely with certain functions within the secure element, while protecting information stored within the secure element. The secure element comprises applications running thereon that perform the functionality described herein. In an example, the secure element comprises components typical of a smart card, such as crypto processors and random generators. In an example, the secure element comprises a Smart MX type NFC controller in a highly secure system on a chip controlled by a smart card operating system, such as a JavaCard Open Platform (JCOP) operating system. In another example, the secure element is configured to include a non-EMV type contactless smart card, as an optional implementation. The secure element communicates with the application 115 in the user computing device 110. In an example, the secure element is capable of storing encrypted user information and only allowing trusted applications to access the stored information. In an example, a controller (not shown) interacts with a secure key encrypted application for decryption and installation in the secure element. Additionally, the secure element also may comprise secure software applications, such as payment applications, secure forms of the applications, authentication applications, payment provisioning applications, or other suitable application using the secure functionality of the secure element.

In an example, the data storage unit 119 and application 115 may be implemented in the secure element, as described previously, on the user computing device 110. In another example, the data storage unit 119, may be a separate memory unit resident on the user computing device 110.

An example user computing device 110 communicates with the product management computing system 120. An example product management computing system 120 comprises a product list unit 121, a shopping unit 123, a server 125, a website 126, and a data storage unit 129. User generated shopping lists are saved in the data storage unit 129.

In an example, the product list unit 121 can access a product listing database and search for product listings for products that are offered for sale or distribution by the product management computing system 120. In another example, the product list unit 121 can search for product listings for products that are offered for sale or distribution by one or more merchant computing systems 150. The product list unit 121 may receive descriptions of one or more products or items from the one or more merchant computing systems 150 over the network 140 and add the descriptions to the product listing database. The product list unit 121 may receive a user generated shopping list and search for product listings in the product listing database for each item in the user generated shopping list. In an example, the product list unit 121 displays product listings to the user for selection by the user. For example, the product list unit 121 displays one or more product listings that correspond to each item in the user generated shopping list in an optimized display of recommended product listings. The optimized display of recommended product listings comprises an interactive graphical user interface 111 in which the user may add, delete, and/or edit product listings in the optimized display of recommended product listings. The product list unit 121 may receive a selection, via the optmized display of recommended product listings, of one or more user interface 111 objects associated with the one or more displayed product listings indicating the desire of the user to purchase the one or more selected product listings. In an example, in response to the user selecting a user interface 111 object to initiate a checkout process, the product list unit 121 communicates the items selected by the user to the shopping unit 123.

In an example, the shopping unit 123 receives one or more product listings selected by the user for purchase. In an example, the shopping unit 123 receives user payment account data and processes a payment transaction for the one or more product listings purchased by the user. For example, the shopping unit 123 communicates, via the network 140 with an issuer system 130 to process a transaction using payment account data associated with the user and payment account data associated with one or more merchant computing systems 150. In an example, the shopping unit 123 communicates with one or more merchant computing systems 150 to notify the one or more merchant computing systems 150 that the one or more product listings have been purchased by the user so that the merchant computing systems 150 may effect shipment of the products associated with the one or more product listings.

In an example, the server 125 provides the content accessible by the user through the web browser 117 and/or application 115 resident on the user computing device 110, including but not limited to html documents, images, style sheets, and scripts. In an example embodiment, the server 125 supports the product management computing system website 126.

In an example, the website 126 is a means by which the user downloads a application 115. In some examples, one or more functions described herein as being performed by the shopping unit 123 or the product list unit 121 may be performed by the website 126.

In an example, the data storage unit 129 can include any local or remote data storage structure accessible to the product management computing system 120 suitable for storing information. In an example, the data storage unit 129 stores encrypted information, such as HTML5 local storage.

An example issuer computing system 130 approves or denies a payment authorization request received from the product management computing system 120 or from one or more merchant computing systems 150. In an example, the issuer computing system 130 communicates with the product management computing system 120 and/or with the one or more merchant computing systems 150 over the network 140. In an example, the issuer computing system 130 communicates with an acquirer computing system to approve a credit authorization and to make payment to the product management computing system 120 and/or to the one or more merchant computing systems 150. For example, the acquirer computing system is a third party payment processing company.

An example merchant computing system 150 registers for an account with the product management computing system 120 and communicates, to the product management computing system 120 via the network 140, one or more product listings for one or more corresponding products offered for sale to include in the product listing database of the product management computing system 120. In an example, one or more merchant computing systems 150 receives a notification that a user has purchased one or more products and prepares shipment of the one or more products.

It will be appreciated that the network connections shown are example and other means of establishing a communications link between the computers and devices can be used. Additionally, those having ordinary skill in the art and having the benefit of the present disclosure will appreciate that the computing devices illustrated in FIG. 1 can have any of several other suitable computer system configurations. For example a user computing device 110 embodied as a mobile phone or handheld computer may not include all the components described above.

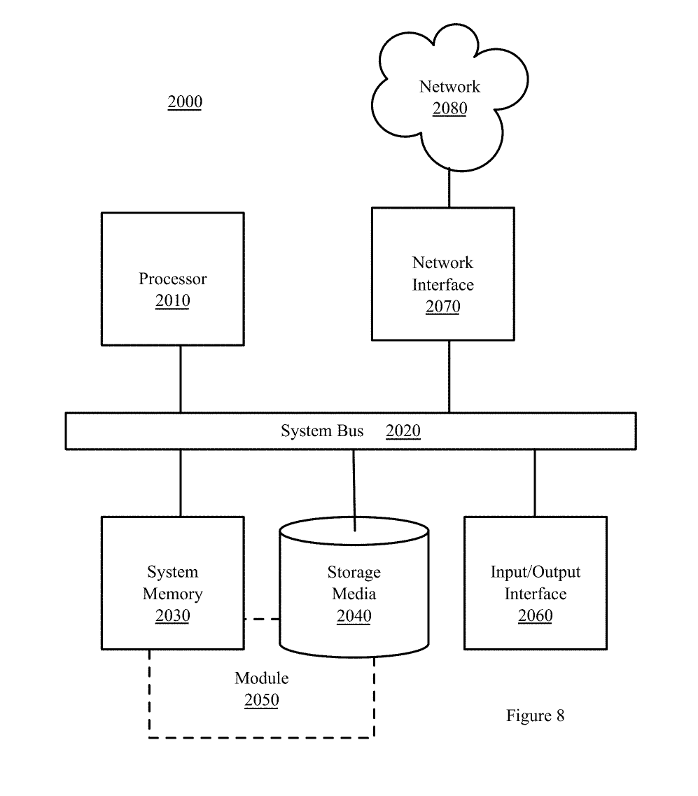

In examples, the network computing devices and any other computing machines associated with the technology presented herein may be any type of computing machine such as, but not limited to, those discussed in more detail with respect to FIG. 8. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 8. The computing machines discussed herein may communicate with one another, as well as with other computing machines or communication systems over one or more networks, such as network 140. The network 140 may comprise any type of data or communications network, including any of the network technology discussed with respect to FIG. 8.

### Example Processes

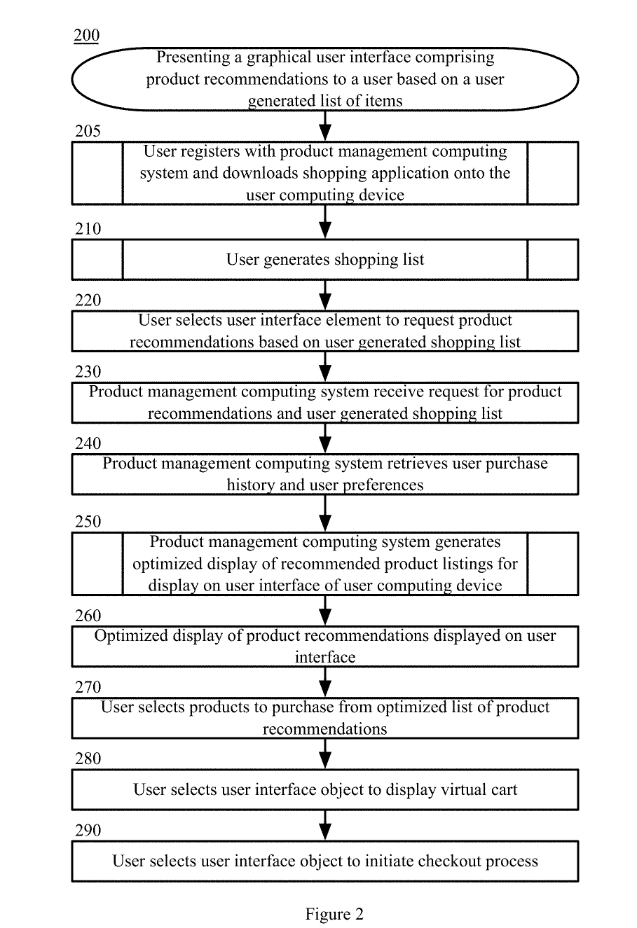

The components of the example operating environment 100 are described hereinafter with reference to the example methods illustrated in FIGS. 2-5. The example methods of FIGS. 2-5 may also be performed with other systems and in other environments. The operations described with respect to any of the FIGS. 2-5 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block flow diagram depicting a method to present a graphical user interface comprising product recommendations to a user based on a user generated list of items, in accordance with certain examples. The method 200 is described with reference to the components illustrated in FIG. 1.

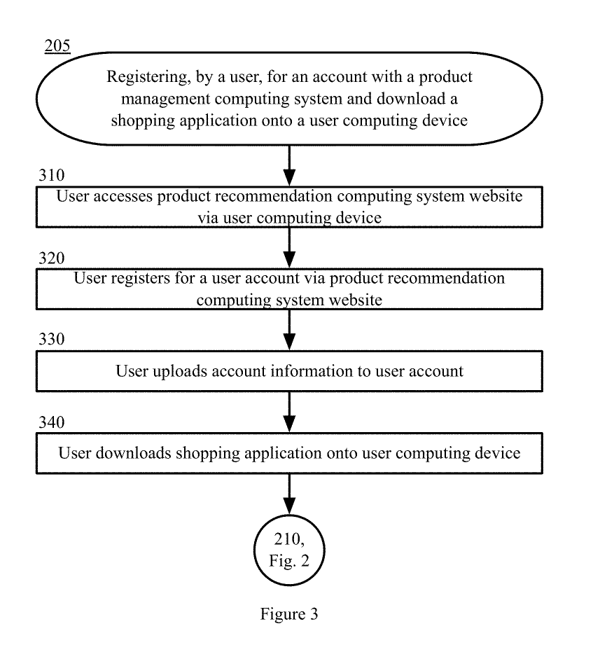

In block 205, the user registers with the product management computing system 120 and downloads a application 115 onto the user computing device 110. The method to register with the product management computing system 120 and download a application 115 onto the user computing device 110 is described in more detail hereinafter with reference to the methods described in FIG. 3.

FIG. 3 is a block flow diagram depicting a method 205 to register, by a user, for an account with a product management computing system 120 and download a application 115 onto a user computing device 110, in accordance with certain examples, as referenced in block 205. The method 205 is described with reference to the components illustrated in FIG. 1.

In block 310, the user accesses a product recommendation computing system website 126 via the user computing device 110. In an example, the user enters the website 126 address into a web browser 117 or otherwise accesses the website 126 over the network 140 via the user interface 111 of the user computing device 110. In an example, the user actuates a user interface 111 object on an advertisement, user interface object, or a link on the web browser and the web browser redirects to the website 126. In another example, the user accesses a platform, digital distribution service, or distribution application over the network 140 via the user computing device 110.

In block 320, the user registers for a user account via the product recommendation computing system website 126. In another example, the user registers for a user account via the platform, digital distribution service, or distribution application. The user may obtain a user account number, receive the appropriate applications and software to install on the user computing device 110, or perform any action required by the product management computing system 120. The user may utilize the functions of the user computing device 110, such as the user interface 111 and a web browser, to register and configure a user account. In an example, the user enters payment account information associated with one or more user accounts, for example, one or more credit accounts, one or more bank accounts, one or more stored value accounts, and/or other appropriate accounts into the user account maintained by the product management computing system 120. In an example, the user configures user account settings, for example, to indicate one or more preferred product listings to be prioritized in optimized displays of recommended product listings generated by the product management computing system 120.

In block 330, the user uploads account information to the user account. In an example, the user may configure user account settings. In an example, the user may add, delete, or edit payment account information via the product management computing system website 126. In an example, the user may add, delete, or edit payment account information via the platform, digital distribution service, or distribution application. In an example, the user may select an option to enable or disable the permission of the product management computing system 120 to process transactions. For example, the payment account information comprises an account number, an expiration date, an address, a user account holder name, or other information associated with the user payment account that would enable the product management computing system 120 to process a payment transaction. In an example, the user can define user preferences that the product management computing system 120 can use to produce product recommendations. For example, user preferences comprise favorite products, favorite brands, favorite merchants, or a combination of a favorite product, a favorite brand, and/or a favorite merchant. For example, user preferences may comprise Merchant A, Brand Z potato chips, and Brand M candles sold at Merchant Z. In an example, the product management computing system 120 deduces user preferences based on user selection and viewing histories.

In block 340, the user downloads the application 115 onto the user computing device 110. In an example, the user selects an option on the product management computing system website 126 to download an application 115 onto the user computing device 110. In an example, the application 115 operating on the user computing device 110 is able to communicate with the product management computing system 120 over the network 140. In an example, the application 115 operating on the user computing device 110 is able to communicate with the product management computing system 120 over the network 140 when the user is signed in to the application 115. In other examples, the user downloads the application 115 onto the user computing device 110 from the platform, digital distribution service, or distribution application.

From block 340, the method 205 proceeds to block 210 in FIG. 2.

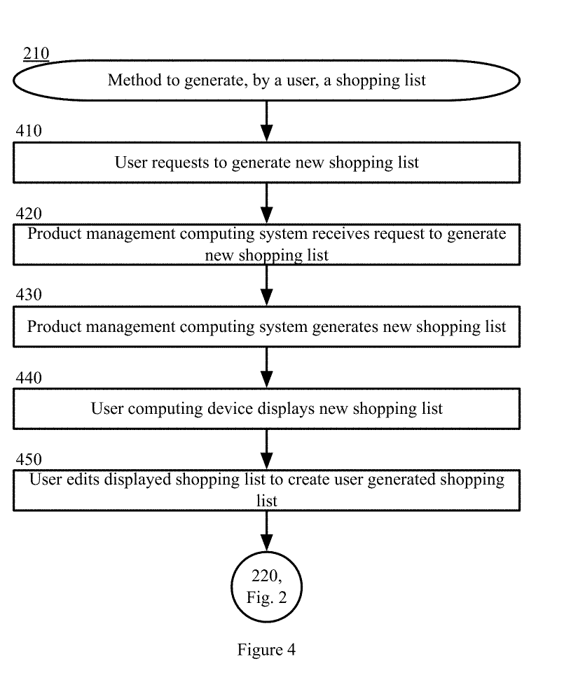

Returning to FIG. 2, in block 210, the user generates a shopping list. The method to generate a shopping list is described in more detail hereinafter with reference to the methods described in FIG. 4.

FIG. 4 is a block flow diagram depicting a method 210 to generate a shopping list, in accordance with certain examples, as referenced in block 210. The method 210 is described with reference to the components illustrated in FIG. 1.

In block 410, the user requests to generate a new shopping list. For example, the user signs into the application 115 on the user computing device 110 and selects a user interface 111 object to request to generate a new shopping list. For example, the user interface 111 object reads “generate new shopping list.” In another example, the user requests to access a previous shopping list previously generated by the user. For example, the user signs into the application 115 on the user computing device 110 and selects a user interface 111 object to request to access a previous user generated shopping list. For example, the user interface 111 object reads “access saved shopping list.”

In an example, a shopping list comprises a listing of one or more terms entered by or on behalf of the user. An example listing of terms comprises generalized terms describing one or more items desired by the user. In an example, the generalized terms comprise an item description or broad category that corresponds to a shopping list item. For example, the generalized term is “milk” instead of the specific terms “Brand A Organic Skim Milk.” In other examples, the listing of terms comprises specific terms entered by or on behalf of the user. In this example, the user enters or the product management computing system 120 determines the specific terms corresponding to the user's desired item.

In block 420, the product management computing system 120 receives the request to generate the new shopping list. For example, in response to receiving an input of a selection of the user interface 111 object, the user computing device 110 transmits a request to generate a new shopping list to the product management computing system 120 via the network 140. In this example, the product management computing system 120 receives the request to generate the new shopping list via the network 140. In another example, the product management system 120 receives the request to access the previous shopping list previously generated by the user. For example, in response to receiving an input of a selection of the user interface 111 object, the user computing device 110 transmits a request to access a previous user generated shopping list to the product management computing system 120 via the network 140. In this example, the product management computing system 120 receives the request to access a previous user generated shopping list via the network 140.

In block 430, the product management computing system 120 generates a new shopping list. In an example, the new shopping list comprises a blank shopping list with no items. In another example, the new shopping list comprises a shopping list populated with suggested product listings determined based on a past user purchase history, based on aggregated data from other users having accounts with the product management computing system 120, and/or based on current advertising campaigns of the product management computing system 120 or of one or more merchant computing systems 150 associated with product listings in the product listings database. In an example, in response to receiving a request for a new shopping list via the network 140, the product management computing system 120 transmits, to the user computing device 110 via the network 140, the new shopping list. In an example, the user computing device 110 receives, via the network 140, the new shopping list from the product management computing system 120.

In another example, in response to receiving a request to access a previous user generated shopping list to the product management computing system 120 via the network 140, the product management computing system 120 retrieves a requested previous shopping list previously generated by the user. In an example, the product management computing system 120 transmits, to the user computing device 110 via the network 140, the retrieved previous shopping list. In an example, the user computing device 110 receives, via the network 140, the retrieved previous shopping list from the product management computing system 120.

In block 440, the user computing device 110 displays the new shopping list via the user interface 111 of the user computing device 110. In an example, the product management system 120 generates a new shopping list in accordance with receiving the request to generate a new shopping list. In this example, the product management computing system 120 generates a blank shopping list. In another example, the product management computing system 120 generates a new shopping list that is pre-populated with one or more recommended items. For example, the product management computing device 120 accesses aggregated user data comprising user generated shopping lists for users that have user accounts with the product management computing system 120 and populates the new shopping list with a predetermined number of items most frequently listed in the user generated shopping lists from the aggregated user data. For example, one or more other users generate shopping lists comprising one or more items with the product management computing system 120, and the product management computing system 120 populates the new shopping list based on the one or more items in the shopping lists of the one or more other users, the product management computing system 120. For example, the product management computing system 120 determines the most popular or most often listed items in the shopping lists. In an example, the product management computing system 120 comprises user preference data and user account data associated with one or more of the one or more other users. In this example, the porduct management computing system 120 may identify one or more users similar to the user from the one or more other users based on the user preference data or the user account data of the user and of the one or more other users. In this example, the product management computing system 120 populates the shopping list with one or more items determined to be popular or often listed by the one or more users similar to the user. In an example, the product management computing system 120 transmits the new shopping list to the user computing device 110 via the network 140 and the user computing device 110 receives the new shopping list from the product management computing system 120 via the network 140.

In another example, the product management computing system 120 generates a new shopping list that is pre-populated with one or more recommended items. For example, the product management computing device 120 accesses aggregated user data comprising user generated shopping lists for users that have user accounts with the product management computing system 120 and populates the new shopping list with a predetermined number of items most frequently listed in the user generated shopping lists from the aggregated user data. In an example, the product management computing system 120 transmits the new shopping list to the user computing device 110 via the network 140 and the user computing device 110 receives the new shopping list from the product management computing system 120 via the network 140.

In other examples, the user computing device 110 displays a previous user generated shopping list via the user interface 111 of the user computing device 110. In an example, the product management system 120 retrieves one or more previous user generated shopping lists in accordance with receiving the request to access a previous user generated shopping list. In an example, the product management computing system 120 assigns a shopping list name or a shopping list identifier to generated shopping lists. In another example, the user assigns a shopping list name or a shopping list identifier to generated shopping lists and the product management computing system 120 stores the generated shopping lists according to the user assigned shopping list name or user assigned shopping list identifier. For example, the product management computing system 120 stores, in the data storage unit 129, one or more previous user generated shopping lists associated with the user account. In an example, the product management computing system 120, in response to receiving the request for a previous user generated shopping list, retrieves the most recently generated shopping list and transmits, via the network 140 to the user comptuing device 110, the most recently generated shopping list. For example, the product management computing system 120 generates a timestamp each time a user generates a new shopping list and stores each of the new user generated shopping lists as previous user generated shopping lists associated with the corresponding timestamp. In this example, the product management computing system 120 retrives the stored previous user generated shopping list having the most recent timestamp.

In another example, the product management computing system 120 transmits, to the user computing device 110 via the network 140, the one or more retrieved prevous user generated shopping lists for selection by the user. In an example, the user computing device 110 displays one or more user interface 111 objects on the user interface 111 of the user computing device 110 for selection by the user of a particular previous user generated shopping list. For example, the user computing device 110 displays a first user interface 111 object that reads “grocery list Aug. 15, 2017” and a second user interface 111 object that reads “holiday shopping list Dec. 5, 2017.” In this example, the user selects, via the user interface 111, the second user interface 111 object that reads “holiday shopping list Dec. 5, 2017” to access the previous user generated shopping list associated with the second user interface 111 object. In an example, in response to receiving an input of a selection of a user interface 111 object associated with a particular previous user generated shopping list, the user computing device 110 transmits a request to the product management computing system 120 for the selected previous user generated shopping list via the network 140. In this example, the product management computing system 120 receives, via the network 140, the request for the selected previous user generated shopping list and transmits, via the network 140, the selected previous user generated shopping list to the user computing device 110. In this example, the user computing device 110 receives, from the product management computing system 120 via the network 140, the selected previous user generated shopping list and displays, via the user interface 111, the selected previous user generated shopping list. In an example, a displayed user generated shopping comprises a list of one or more items with user interface objects corresponding to each of the one or more listed items. In an example, the displayed user generated shopping list comprises user interface 111 objects to add an item, to delete an item, edit an item, and to request product recommendations for all of the items in the shopping list. In an example, the displayed user generated shopping list comprises a user interface 111 object beside each item on the list that enables the user to select one or more items. In an example, the user generated shopping list comprises a user interface 111 object to request product recommendations that correspond to currently selected items in the shopping list.

In block 450, the user edits the displayed shopping list to create a user generated shopping list. In some examples, the displayed shopping list is a new shopping list comprising a blank shopping list. In other examples, the displayed shopping list is a new shopping list that is pre-populated by the product management computing system 120 with one or more recommended items. In yet other examples, the displayed shopping list is a previous user generated shopping list stored by the product management computing system 120 and selected by the user. In an example, the user edits the displayed shopping list by selecting one or more user interface 111 objects and/or entering text via the user interface 111 of the user computing device 110. For example, the user enters a new item on the shopping list by selectin a user interface 111 object that reads “add item” and then enters text for the new item. In another example, the user deletes an item on the shopping list by selecting a user interface 111 object associated with the item the user desires to delete and selecting a second user interface 111 object that reads “delete item.” In yet another example, the user edits an existing item on the shopping list by selecting a user interface 111 object associated with the item on the shopping list that the user desires to edit, selecting a second user interface 111 object that reads “edit item,” and then editing the text associated with the selected item via the user interface 111 of the user computing device 110. In an example, the product management computing system 120 communicates with the user computing device 110 via the network 140 and receives any updates to the displayed shopping list based on the additions, deletions, and/or edits of the user. In an example, the user may enter a title of the displayed shopping list or edit an existing title of the displayed shopping list via the user interface 111.

In an example, an application, computing device, or computing system adds one or more terms to the shopping list on behalf of the user. For example, a home computing device receives a voice input from a user comprising the user speaking the words “order more sugar” and transmits the voice input to a product management computing system 120 over the network 140 and a user account identifier associated with the user account. The product management computing system 120 receives the voice input via the network 140 and interprets the voice input as a command to add “sugar” to the most recent user generated shopping list associated with the user associated with the received user account identifier.

From block 450, the method 210 proceeds to block 220 in FIG. 2.

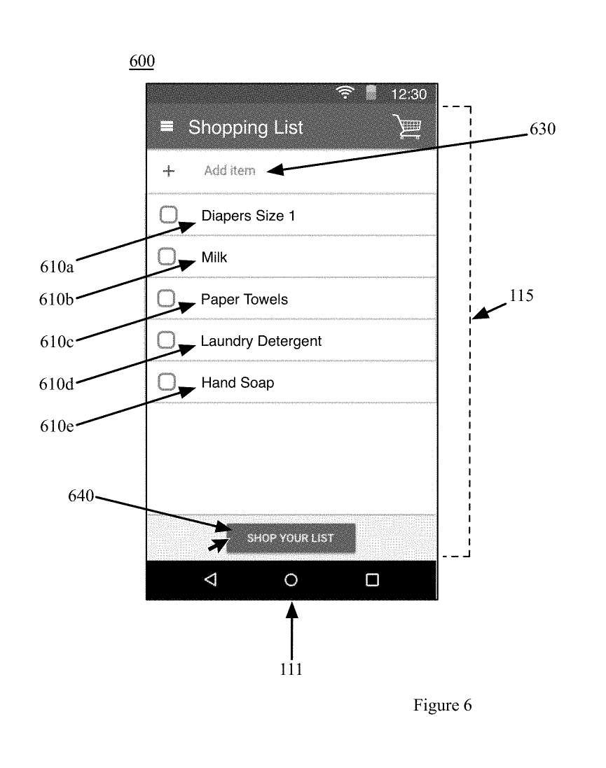

FIG. 6 is an example illustration of a graphical user interface comprising a user generated list of items, in accordance with certain examples. FIG. 6 describes an example shopping list displayed in a application 115 on a user interface 111. Items 610a, 610b, 610c, 610d, and 610e that read “Diapers Size 1,” “Milk,” “Paper Towels,” “Laundry Detergent,” and “Hand Soap,” respectively, are diplayed on the shopping list along with associated user interface 111 objects. User interface object 630 that reads “+Add item” may be selected by the user via the user interface 111 to add a new item to the displayed shopping list. User interface object 640 that reads “shop your list” may be selected by the user to request an optimized display of product recommendations based on the displayed user generated shopping list.

Returning to FIG. 2, in block 220, the user selects a user interface 111 element to request product recommendations based on the user generated shopping list. For example, after editing the displayed shopping list, the user selects a user interface 111 object that reads “shop your list” or otherwise selects a user interface 111 object indicating a request for an optimized display of recommended products that correspond to the user generated product list. In an example, in response to receiving an input of a selection of the user interface 111 element indicating a request for product recommendations, the user computing device 110 transmits, via the network 140 to the product management computing system 120, a request for an optimized display of product recommendations along with the user generated shopping list. In another example, the user computing device 110 transmits, via the network 140 to the product management computing system 120, a request for an optimized display of product recommendations along with the shopping list name or the shopping list identifier associated with the user generated shopping list for which the user is requesting product recommendations. In another eample, the user selects a user interface 111 element to request objects that correspond to the items on the user generated shopping list.

In another example, the user selects a user interface 111 element to request product recommendations for selected items on the user generated shopping list. For example, after editing the displayed shopping list, the user selects user interface 111 objects corresponding to one or more of the items on the list to select the items and then selects a user interface 111 object that reads “shop selected items on your list” or otherwise selects a user interface 111 object indicating a request for an optimized display of recommended products that correspond to the selected items on the user generated product list. In another eample, the user selects a user interface 111 element to request objects that correspond to the selected items on the user generated shopping list.

In block 230, the product management computing system 120 receives the request for product recommendations and the user generated shopping list. For example, the product management computing system 120 receives the request for product recommendations and the user generated shopping list from the user computing device 110 via the network 140. For example, the product management computing system 120 receives the request for objects that correspond to the items on the user generated shopping list from the user computing device 110 via the network 140. In another example, the product management computing system 120 receives the request for product recommendations, the shopping list identifier or user shopping list name associated with the user generated shopping list, and a user identifier associated with the user via the network 140 from the user computing device 110. In this example, the product management computing system 120 retrieves shopping lists associated with the user account identifier, identifies the shopping list associated with the received shopping list name or the received shopping list identifier, and identifies the one or items in the identified shopping list that corresponds to the shopping list name or shopping list identifier.

In block 240, the product management computing system 120 retrieves user purchase history and user preferences. In an example, the user purchase history comprises one or more products purchased by the user that were previously recommended by the product management computing system 120 for one or more previous user generated shopping lists. In an example, user preferences may comprise preferred products and a user may mark one or more product listings of the product management computing system 120 as preferred products when editing optimized displays of recommended products so that the product management computing system 120 can prioritize such preferred products when presenting product recommendations to the user in the future. In another example, user preferences comprise products or objects that the user has viewed and/or selected in the application 115 or web browser 117. In yet another example, user preferences comprise products or objects that the user has purchased in the past via the product managemetn computing system 120.

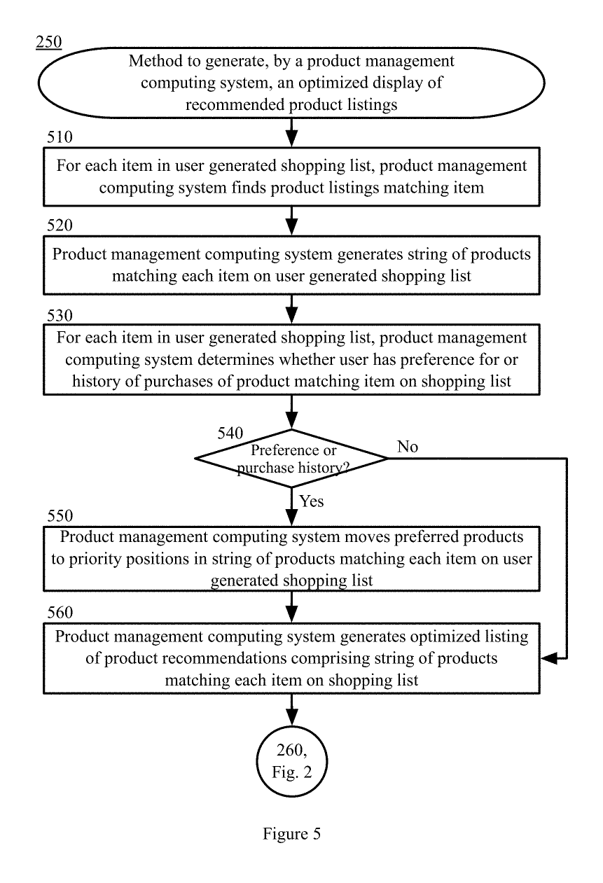

In block 250, the product management computing system 120 generates an optimized display of recommended product listings for display on the user interface 111 of the user computing device 110. The method to generate, by a product management computing system 120, an optimized display of recommended product listings for display on a user interface 111 of a user computing device 110 is described in more detail hereinafter with reference to the methods described in FIG. 5.

FIG. 5 is a block flow diagram depicting a method 250 to generate, by a product management computing system 120, an optimized display of recommended product listings for display on a user interface 111 of a user computing device 110, in accordance with certain examples, as referenced in block 250. The method 250 is described with reference to the components illustrated in FIG. 1.

In block 510, for each item in the user generated shopping list, the product management computing system 120 finds product listings matching the item. For example, in response to receiving a request for product recommendations associated with a user generated shopping list, the product management computing system 120 searches, for each item on the user generated shopping list, a product listing database for available product listings associated with each item. For example, the product management computing system 120 compares the text of an item in shopping list to text of descriptions of each of the product listings in the product listing database and finds a match if there is a correspondence between the text of the item in the shopping list to the text of a product listing in the product listing database. For example, the user generated shopping list comprises an item entitled “candles” and the product management computing system 120 finds matching product listings comprising “Merchant A, one dozen 8-inch beeswax candles, ¼ inch diameter,” “Merchant A, one dozen 6-inch beeswax candles, ¼ inch diameter,” “Merchant B, 24 count birthday cake candles,” “Merchant C, fragrant jar candle, lavender scent” “Merchant C, fragrant jar candle, vanilla scent.”

In block 520, the product management computing system 120 generates a string of products matching each item on the user generated shopping list. For example, the product management computing system 120 finds matching product listings for an item in the user generated shopping list and then selects a predetermined number of matching product listings to include in the string of products. In an example, the predetermined number of matching product listings comprises ten matching product listings, twenty matching product listings, or another appropriate number of matching product listings. Advantages to using a higher predetermined number of matching product listings is that the user may be presented with a wider variety of results, and disadvantages are that the results may be less relevant to the item on the list the larger the predetermined number. Advantages to using a lower predetermined number of matching product listings are that the results are more targeted and relevant to the user, and disadvantages are that the user is presented with less variety of results. In an example, the product management computing system 120 may further determine an order or priority of listing for the string of products based on popularity data associated with the product. For example, the product management computing system 120 accesses aggregated popularity data for users having accounts with the product management computing system 120 and who have made past purchases with the product management computing system 120. For example, if product A has been purchased 5,000 times and product B has been purchased 2,000 times, the product management computing system 120 prioritizes product A over product B in the string of products associated with the particular item on the user generated shopping list. In another example, the product management computing system 120 priorities product listings in the string of product listings for a particular item in the user generated shopping list based on advertising priority data. For example, the product management computing system 120 has advertising agreements with one or more merchant computing systems 150 or advertising systems and prioritizes product listings subject to those agreements in the string of products associated with a particular item on the user generated shopping list.

In block 530, for each item in the user generated shopping list, the product management computing system 120 determines whether the user has a preference for or history of purchases of products matching the item on the user generated shopping list. For example, the user purchase history comprises one or more products purchased by the user that were previously recommended by the product management computing system 120 for one or more previous user generated shopping lists. In an example, user preferences may comprise preferred products and a user may mark one or more product listings of the product management computing system 120 as preferred products when editing optimized displays of recommended products so that the product management computing system 120 can prioritize such preferred products when presenting product recommendations to the user in the future.

In block 540, the product management computing system 120 determines whether there is a user preference or purchase history matching each item on the user generated shopping list. For example, the product management computing system 120 compares text between the user preferences or purchase history against text from each item in the user generated shopping list. In an example, the product management computing system 120 extracts user purchase history, user activity history, and/or user preferences associated with the user account. For example, user preferences comprise products that the user has viewed and/or selected previously via the user interface 111. For example, the user previously viewed and/or selected the user preference “Brand A milk sold by Merchant M” via the user interface 111. In this example, the product management computing system 120 determines that this user preference corresponds to an item named “milk” on the user generated shopping list and determines that this user preference is applicable to the item on the user generated shopping list. For example, user purchase history or user activity history comprise products that the user has purchased or for which the user has initiated a service request. For example, the user previously purchased “Brand B dish soap” via the user interface 111. In this example, the product management computing system 120 determines that this previously purchased item corresponds to an item named “dish soap” on the user generated shopping list and determines that this purchased product from the user purchase history is applicable to the item on the user generated shopping list.

If the product management computing system 120 does not find any user preferences or purchase history matching any item on the user generated shopping list, the method 250 proceeds to block 560. In block 560, the product management computing system 120 generates an optimized listing of product recommendations comprising the string of products matching each item on the shopping list. In this example, the product management computing system 120, not finding any user preferences or purchase history matching the particular item on the user generated shopping list, does not prioritize product listings within the string of products for the particular item on the user generated shopping list based on user preferences or user purchase history.

Returning to block 540, if the product management computing system 120 finds user preferences or purchase history matching one or more items on the user generated shopping list, the method 250 proceeds to block 550. For example, the product management computing system 120 determines that the user has previously purchased one or more of the product listings in the string of product listings for a particular item in the user generated shopping list. In another example, the product management computing system 120 determines that the user has added one or more of the product listings to a wish list or otherwise previously indicated interest in the one or more product listings.

In block 550, the product management computing system 120 moves any preferred products to priority positions in the string of products matching each item on the user generated shopping list. For example, for each item on the user generated shopping list, the product management computing system 120 moves product listings that have been previously purchased by the user to the front of the string of product listings associated with the item. For example, for each item on the user generated shopping list, the product management computing system 120 moves product listings that have been selected by the user, entered into a user wish list, or otherwise are preferred by the user to the front of the string of product listings associated with the item.

In block 560, the product management computing system 120 generates an optimized display of product recommendations comprising the string of products matching each item on the shopping list. In an example, the product management computing system 120 generates an optimized listing of product recommendations comprising the string of products matching each item on the shopping list, wherein the product management computing system 120 has moved any preferred products or previously purchased products to priority positions in each string of products. In an example, the optimized listing of product recommendations is organized according to each item on the user generated shopping list and comprises product listings and associated user interface 111 objects that enable a user to add each product listing to a virtual cart if the user desires. In an example, the product management computing system 120 transmits the generated optimized display of product recommendations to the user computing device 110 via the network 140. In an example, the user computing device 110 receives the optimized display of product recommendations from the product management computing system 120 via the network 140.

From block 560, the method 250 proceeds to block 260 in FIG. 2.

Returning to FIG. 2, in block 260, the optimized display of product recommendations is displayed on the user interface 111. In an example, the optimized display of product recommendations comprises a graphical user interface 111 comprising product listings organized according to each item on the user generated shopping list and comprises product listings and associated user interface 111 objects that enable a user to add each product listing to list of desired products. For example, for each item on the user generated shopping list, the corresponding string of products is displayed. The user may scroll, swipe, or otherwise navigate through product listings associated with each item and may select one or more user interface 111 objects to add one or more product listings to a virtual cart.

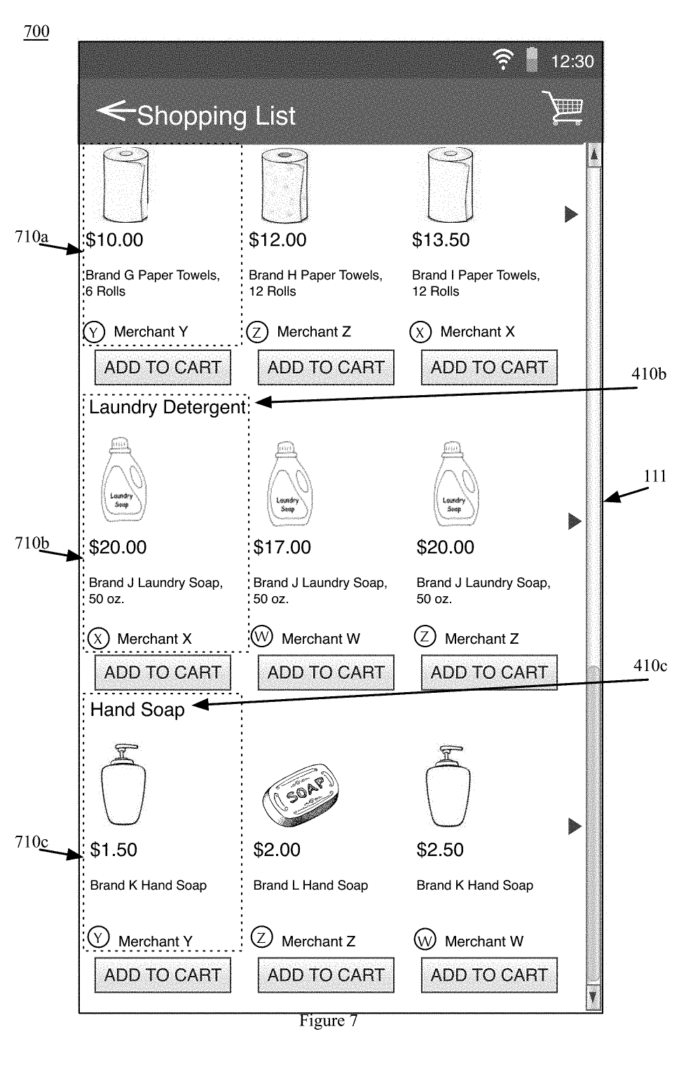

FIG. 7 is an example illustration of a graphical user interface comprising an optimized display of product recommendations, in accordance with certain examples. In FIG. 7, a user interface 111 is shown displaying an optimized display of product recommendations, organized according to items. For example, items 410b and 410c comprise “Laundry Detergent” and “Hand Soap,” respectively, and under each item are displayed three product listings. For example, under “Laundry Detergent,” the optimized display of prouct recommendations displays product listings comrpising “Brand J Laundry Soap, 50 oz” from Merchant X, from Merchant W, and from Merchant Z, along with associated prices and user interface 111 objects that, if selected, enable the user to add any of the displayed product listings to a virtual cart. Further, on the right hand side of the three products is an arrow where the user may scroll or swipe to see more products under the item “Laundry Detergent.”

Returning to FIG. 2, in block 270, the user selects products to purchase from the optimized list of product recommendations. In some examples, the user selects products from the optimized list of product recommendations to add to a list of desired products. For example, the user may scroll, swipe, or otherwise navigate through product listings associated with each item and may select one or more user interface 111 objects to add one or more product listings to a virtual cart. For example, the user may select one or more user interface 111 objects for one or more product listings under each item from the user generated shopping list in the optimized display of product recommendations to add the selected product listings to a virtual cart.

In block 280, the user selects a user interface 111 object to display the list of desired products. For example, the user added one or more product listings to the list of desired products from the optimized display of product recommendations. In this example, the user selects a user interface 111 object to proceed to the list of desired products. In this example, the user computing device 110 displays the list of desired products, comprising all product listings selected by the user to add to the list of desired products. For example, the user computing device 110 accesses the list of desired products from the product management computing system 120 via the network 140. For example, the user computing device 110 accesses the list of desired products from the product management computing system 120 via the network 140. The user may edit the list of desired products via the user interface 111 to add, delete, or change the quantity of desired product listings in the list of desired products. In an example, the user computing device 110 and the product management computing system 120 communicate via the network 140. In certain examples, the list of desired products comprises a virtual cart. An example virtual cart may display a description of each product listing in the list of desired products, pricing information for each product listing, a subtotal comprising a sum of all product listings being purchased, taxes and fees that apply, shipping, and a total price including taxes, fees, and shipping. In an example, the virtual cart comprises user interface 111 objects that enable the user to select a method of payment. In an example, the user selects multiple product listings, some product listings from a first merchant and some product listings from a second merchant. In another example, the user selecst multiple product listings, some product listings available for shipment from a first location and other product listings available for pickup a second location.

In block 290, the user selects a user interface 111 to initiate a checkout process. In this example, the user reviews the virtual cart displayed by the user computing device 110, comprising all product listings selected by the user for purchase and is satisfied with the purchase. In an example, a confirmation screen may display information summarizing the potential transaction and comprising one or more of a transaction total, a description of the one or more product listings being purchased by the user, and an indication that the user selected a payment option for a method of payment for the transaction. An example confirmation screen may further display options to confirm the transaction or cancel the transaction. In an example, the user reviews the confirmation screen, determines that the information displayed on the confirmation screen is correct, determines to continue with the transaction, and selects the option to confirm the transaction via the user interface 111. In another example, the user decides to abandon the transaction because the information is incorrect or because the user changed his mind and decided not to purchase the product listings. In yet another example, the confirmation screen further comprises an option to edit the transaction details. In this example, the user may select the option to edit the transaction details and may then edit, add, or delete one or more of the product listings in the transaction or edit payment details or payment methods for the transaction.

In an example, the user may provide transaction data or may select payment account data stored by the product management computing system 120 in a digital wallet account of the user. The product management computing system 120 may generate a payment authorization request using payment account information associated with the user's payment account. Example payment account information comprises an account holder name, an account number, a card verification value or code, an address associated with the payment account, a zip code associated with the payment account, or other information necessary to generate a payment authorization request. A payment account may comprise a credit account, a bank account, a stored value account, a coupon, a loyalty program account, or other user payment account. In an example, the product management computing system 120 transmits the payment authorization request to the issuer system associated with the user payment account information. In certain examples, the product management computing system 120 routes the payment authorization request to the issuer system via an acquirer system.

In an example, the issuer system receives the payment authorization request and identifies the payment account associated with the authorization request. In an example, the issuer system determines whether to approve or to decline the payment authorization request. In an example, a credit card issuer system determines whether to approve or decline the payment transaction based on the user's current balance, the user's credit limit, and/or the amount of the current transaction. In another example, a coupon issuer system determines whether to approve or decline the payment transaction based on the conditions imposed by a coupon being used in the transaction and transaction data received from the product management computing system 120. For example, a credit card issuer system approves the payment transaction because the user credit limit and current credit balance are such that the current transaction amount will not cause the user's credit balance to exceed the credit limit. In another example, a coupon issuer system approves the payment transaction based on the data received from the product management computing system 120. In this example, the coupon issuer system determines that the user satisfies the coupon terms and conditions based on the data received from the product management computing system 120. In another example, a credit card issuer system declines the payment transaction because the user credit limit and current credit balance are such that the current transaction amount would cause the user's credit balance to exceed the credit limit. In yet another example, a coupon issuer system declines the payment transaction based on the data received from the product management computing system 120. In this example, the coupon issuer system determines that the user satisfies the coupon terms and conditions based on the data received from the product management computing system 120.

An example notice of authorized payment transaction may comprise a transaction number, a confirmation number, a transaction amount, a portion of the user account number used in the transaction, a time of transaction, and/or any other useful or relevant information to the transaction. In an example, the issuer system generates the notice of approved payment authorization request and transmits the notice of approved payment authorization request via the network 140 to the product management computing system 120. In another example, a notice of declined payment authorization request may comprise an error message that indicates that the payment transaction using the payment account was declined. In another example, the issuer system generates the notice of declined payment authorization request and transmits the notice of declined payment authorization request via the network 140 to the product management computing system 120.

In an example, the product management computing system 120 receives the notice of approved payment authorization request and transmits a receipt to the user computing device 110. For example, the product management computing system 120 receives the notice of approval of the payment authorization request via the network 140. In another example, the product management computing system 120 receives a notice of declined payment authorization request via the network 140. In an example, the product management computing system 120 forwards the notice of approved payment authorization request or the notice of declined payment authorization request to the user computing device 110 via the network 140. In an example, the user computing device 110 receives the notice of approved payment authorization request or the notice of declined payment authorization request via the network 140 and generates a receipt based on the received approved payment authorization request or the received declined payment authorization request. In another example, the product management computing system 120 transmits the notice of approved or declined transaction and a listing of one or more products purchased by the user to one or more merchant computing systems 150 associated with the purchased product listings so that the merchant computing systems 150 may ship the products and reimburse the product management computing system 120 for any cost of transaction. In another example, the product management computing system 120 transmits the notice of approved or declined transaction and a listing of one or more products purchased by the user to one or more merchant computing systems 150 associated with the purchased product listings so that the merchant computing systems 150 may prepare the products for the user to pickup in person. In an example, the one or more merchant computing systems 150 receive the notice of approved payment authorization request or the notice of declined payment authorization request and the product listings purchased by the user via the network 140 and ship the purchased products to the user.

In an example, after a user purchases one or more products corresponding to one or more product listings that were displayed on the optimized display of recommended products, the purchased products are designated as preferred products of the user in the database of product listings. In this example, in future optimized displays of recommended products generated based on future shopping lists generated by the user, these purchased products, if applicable to any of the items in the shopping list, will be prioritized in the optimized display of recommended products.

### Other Example Embodiments

FIG. 8 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to generate graphical user interfaces comprising optimized displays of objects, comprising:
receiving, by one or more computing devices, a first notification of selection of a first user interface element on a first graphical user interface of a user computing device requesting presentation of objects corresponding to each of a plurality of items in a list of item entries;
determining, by the one or more computing devices, two or more objects, each object corresponding to a respective one of the plurality of items in the list of item entries;
rendering, by the one or more computing devices, a second graphical user interface on the user computing device, the second graphical user interface comprising each of the two or more objects, wherein each of the two or more objects comprises a description corresponding to the respective one of the plurality of items in the list of item entries and a second user interface element to select the respective one of the plurality of items;
receiving, by the one or more computing devices, a second notification of selection of the second user interface element on the second graphical user interface on the user computing device selecting a particular one of the two or more objects rendered on the second graphical user interface;
receiving, by the one or more computing devices, a third notification of selection of a third user interface element on the second graphical user interface of the user computing device requesting a presentation of each selected object from the two or more objects rendered on the second graphical interface; and
rendering, by the one or more computing devices, a third graphical user interface on the user computing device, the third graphical user interface comprising a display of each selected object.

2. The computer-implemented method of claim 1, further comprising, selecting, by the one or more computing devices and for at least one of the plurality of items in the list of item entries, a predetermined number of corresponding objects, wherein the two or more objects corresponding to each of the plurality of items in the list of item entries rendered on the second graphical user interface comprise the selected predetermined number of objects.

3. The computer-implemented method of claim 1, further comprising rendering, by the one or more computing devices on the user computing device, the first graphical user interface comprising the plurality of items in the list of item entries.

4. The computer-implemented method of claim 1, further comprising:
receiving, by the one or more computing devices, a request for a particular list of item entries;
retrieving, by the one or more computing devices, the particular list of item entries;
rendering, by the one or more computing devices, a graphical user interface on the user computing device, wherein the graphical user interface comprises the particular list of item entries; and
receiving, by the one or more computing devices, input of a change to the particular list of item entries rendered on the graphical user interface of the user computing device, wherein the plurality of items in the list of item entries renderend on the first graphical user interface comprises the change.

5. The computer-implemented method of claim 1, further comprising:
receiving, by the one or more computing devices, a request for a new list of item entries;
retrieving, by the one or more computing devices, item preferences;
generating, by the one or more computing devices, a new list of item entries based on the item preferences;
rendering, by the one or more computing devices, a graphical user interface comprising the generated new list of item entries; and
receiving, by the one or more computing devices, input of a change to the new list of item entries rendered on the graphical user interface of the user computing device, wherein the plurality of items in the list of item entries rendered on the first graphical interface comprises the change.

6. The computer-implemented method of claim 5, wherein the item preferences comprise preferences provided by a third party computing system and wherein the new list of item entries is generated based on the preferences provided by the third party computing system.

7. The computer-implemented method of claim 1, wherein the second graphical user interface comprises user interface elements representing each of the plurality of items in the list and wherein the two or more objects are associated with corresponding object user interface elements representing each of the plurality of items in the list of item entries.

8. The computer-implemented method of claim 1, further comprising:
retrieving, by the one or more computing devices, user activity information; and
prioritizing, by the one or more computing devices, the two or more objects corresponding to each of the plurality of items in the list of item entries according to the user activity information.

9. The computer-implemented method of claim 1, further comprising:
retrieving, by the one or more computing devices, user preference information; and
prioritizing, by the one or more computing devices, the two or more objects corresponding to each of the plurality of items in the list of item entries according to the user preference information.

10. A computer program product, comprising:
a non-transitory computer-readable storage device having computer-executable program instructions embodied therein that when executed by a computer cause the computer to generate graphical user interfaces comprising optimized displays of listings, the computer-readable program instructions comprising:
computer-readable program instructions to receive a first notification of selection of a first user interface element on a first graphical user interface of a user computing device requesting presentation of objects corresponding to each of a plurality of items in a list of item entries;
computer-readable program instructions to determine two or more objects, each object of the two or more objects corresponding to a respective one of the plurality of items in the list of item entries;
computer-readable program instructions to render a second graphical user interface on the user computing device, the second graphical user interface comprising each of the two or more objects corresponding to each of the plurality of items in the list of item entries and a second user interface element, wherein each of the two or more objects comprises a description corresponding to the respective one of the plurality of items in the list of item entries and a second user interface element to select the respective one of the plurality of items;
computer-readable program instructions to receive a selection of the second user interface element on the second graphical user interface on the user computing device selecting a particular one of the two or more objects rendered on the second graphical user interface;
computer-readable program instructions to receive a third notification of selection of a third user interface element on the second graphical user interface of the user computing device requesting a presentation of each selected object from the two or more objects rendered on the second graphical interface; and
computer-readable program instructions to render a third graphical user interface on the user computing device, the third graphical user interface comprising a display of each selected object.

11. The computer program product of claim 10, further comprising computer-readable program instructions to select, for each item, a predetermined number of the one or more objects corresponding to the item, wherein the one or more objects corresponding to each item in the first graphical user interface comprise the selected predetermined number of the one or more objects corresponding to each item.

12. The computer program product of claim 10, further comprising computer-readable program instructions to render, on the user computing device, the first graphical user interface comprising the plurality of items in the list of item entries.

13. The computer program product of claim 10, further comprising:
computer-readable program instructions to receive a request for a particular list of item entries;
computer-readable program instructions to retrieve the particular list of item entries;
computer-readable program instructions to render a graphical user interface on the user computing device, wherein the graphical user interface comprises the particular list of item entries; and
computer-readable program instructions to receive input of a change to the particular list of item entries rendered on the graphical user interface of the user computing device, wherein the plurality of items in the list of item entries renderend on the first graphical user interface comprises the change.

14. The computer program product of claim 10, further comprising:
computer-readable program instructions to retrieve user preference information; and
computer-readable program instructions to prioritize the two or more objects corresponding to each of the plurality of items in the list of item entries according to the user preference information.

15. A system to generate graphical user interfaces comprising optimized displays of listings, comprising:
a storage device; and
a processor communicatively coupled to the storage device, wherein the processor executes application code instructions that are stored in the storage device to cause the system to:
receive a first notification of selection of a first user interface element on a first graphical user interface of a user computing device requesting presentation of objects corresponding to each of a plurality of items in a list of item entries;
determine two or more objects, each object corresponding to a respective one of the plurality of items in the list of item entries;
render a second graphical user interface on the user computing device, the second graphical user interface comprising each of the two or more objects, wherein each of the two or more objects comprises a description corresponding to the respective one of the plurality of items in the list of item entries and a second user interface element to select the respective one of the plurality of items;
receive a second notification of selection of the second user interface element on the second graphical user interface on the user computing device selecting a particular one of the two or more objects rendered on the second graphical user interface;
receive a third notification of selection of a third user interface element on the second graphical user interface of the user computing device requesting a presentation of each selected object from the two or more objects rendered on the second graphical interface; and
render a third graphical user interface on the user computing device, the third graphical user interface comprising a display of each selected object.

16. The system of claim 15, wherein the processor is further configured to execute application code instructions stored in the storage device to cause the system to:
receive a request for a particular list of item entries;
retrieve the particular list of item entries;
render a graphical user interface on the user computing device, wherein the graphical user interface comprises the particular list of item entries; and
receive input of a change to the particular list of item entries rendered on the graphical user interface of the user computing device, wherein the plurality of items in the list of item entries renderend on the first graphical user interface comprises the change.

17. The system of claim 15, wherein the processor is further configured to execute application code instructions stored in the storage device to cause the system to:
receive a request for a new list of item entries;
retrieve item preferences;
generate a new list of item entries based on the item preferences;
render a graphical user interface comprising the generated new list of item entries; and
receive input of a change to the new list of item entries rendered on the graphical user interface of the user computing device, wherein the plurality of items in the list of item entries rendered on the first graphical interface comprises the change.

18. The system of claim 15, wherein the processor is further configured to execute application code instructions stored in the storage device to cause the system to receive, from the user computing device, the list of one or more items.

19. The system of claim 17, wherein the item preferences comprise preferences provided by a third party computing system and wherein the new list of item entries is generated based on the preferences provided by the third party computing system.

20. The system of claim 19, wherein the second graphical user interface comprises user interface elements representing each of the plurality of items in the list and wherein the two or more objects are associated with corresponding object user interface elements representing each of the plurality of items in the list of item entries.
